(19) United States
(12) Patent Application Publication
(10) Pub. No.: US 2005/0211041 A1
(43) Pub. Date: Sep. 29, 2005

(54) Punch capable of punching and embossing simultaneously

(76) Inventor: Wan-Young Oh, Seoul (KR)

Correspondence Address: JONES DAY, 222 EAST 41ST ST, NEW YORK, NY, 10017, US

(21) Appl. No.: 10/886,391

(22) Filed: Jul. 6, 2004

(30) Foreign Application Priority Data
Mar. 26, 2004 (KR) 20-2004-0008480

(51) Int. Cl. B26D 5/08

(52) U.S. Cl. 83/588; 83/622

(57) ABSTRACT

A punch capable of simultaneously punching and embossing a sheet member such as a card, a letter paper, a picture, a board, or a paper in a predetermined pattern is disclosed. The punch includes a jig having a cutting hole of a predetermined pattern and a punching area on which a convex embossment is spaced apart from the cutting hole; a base for fixing the jig and giving a support surface to supply a sheet member to the punching area; a punching member including a first punch pin having a cutting blade corresponding to the cutting hole and a second punch pin having a concave embossment corresponding to the convex embossment, the punching member punching and embossing the supplied sheet member with moving vertically against the jig; and an elastic body interposed between the punching member and the jig to bias the punching member upward.

### BACKGROUND OF THE INVENTION

1. Field of the Invention

The present invention relates to a punch, and more particularly to a punch capable of simultaneously punching and embossing a sheet member such as a card, a letter paper, a picture, a board, or a paper in a predetermined pattern.

2. Description of the Related Art

A punch generally includes a jig having a cutting hole of a predetermined pattern, a base for supporting the jig below it, and a punching member having a sharp cutting blade which slides through the cutting hole of the jig. This punch punches a sheet member according to the pattern of the cutting hole when the punching member passes through the jig by means of the stroke operation for descending the punching member toward the jig while the predetermined sheet member is put into a corresponding punching area of the jig.

In the punch configured as mentioned above, it is also possible to form an embossing design of a predetermined pattern in the sheet member if a convex embossment (or, a concave embossment) of a predetermined pattern is formed on the surface of the jig and a concave embossment (or, a convex embossment) in correspondence with the convex embossment (or, the concave embossment) is formed at the front end of the punching member.

However, since the conventional punch is configured just to perform either a punching function or an embossing function, a user should handle two kinds of punches to decorate a sheet member with a punching design and an embossing design together. In addition, when using each punch, the user may measure a punching point and an embossing point just with the eye whenever conducting the punching or embossing work, so the obtained punching and embossing patterns are irregular, and even a complex design is impossible to work.

### SUMMARY OF THE INVENTION

The present invention is designed to solve the problems of the prior art, and therefore it is an object of the present invention to provide a punch capable of simultaneously punching and embossing a sheet member in a predetermined pattern by just one stroke.

Another object of the invention is to provide a punch capable of forming various punching and embossing designs, which is impossible in the prior art, by mixing a punching member with pins for embossing in various ways.

In order to accomplish the above object, the present invention provides a punch, which includes a jig having a cutting hole of a predetermined pattern, and a punching area on which a convex embossment (or, a concave embossment) is formed at a position spaced apart from the cutting hole; a base to which the jig is fixed, the base giving a support surface so that a sheet member to be punched is supplied to the punching area; a punching member including a first punch pin having a cutting blade corresponding to the cutting hole and a second punch pin having a concave embossment (or, a convex embossment) corresponding to the convex embossment (or, the concave embossment), the punching member punching and embossing the supplied sheet member with moving up and down against the jig; and an elastic body interposed between the punching member and the jig so as to bias the punching member upward.

Preferably, the jig has an upper plate and a lower plate which are faced in parallel with each other so that a gap is interposed therebetween for insertion of the sheet member to be punched, and the first punch pin is longer than the second punch pin as much as at least the gap of the jig.

The cutting hole is preferably formed in the upper and lower plates of the jig, the convex embossment (or, the concave embossment) is preferably formed on the lower plate of the jig, and a guide hole for guiding movement of the second punch pin is also preferably formed in the upper plate of the jig.

According to another aspect of the invention, there is also provided a punch, which includes a jig having a cutting hole of a predetermined pattern, and a punching area on which a convex embossment (or, a concave embossment) of a predetermined pattern is formed at a position adjacent to the cutting hole; a base to which the jig is fixed, the base giving a support surface so that a sheet member to be punched is supplied to the punching area; a punching member having punch pins for punching and embossing the supplied sheet member with moving up and down against the jig; and an elastic body interposed between the punching member and the jig so as to bias the punching member upward, wherein at least one of the punch pin includes an embossing unit having a first front end surface on which a concave embossment (or, a convex embossment) corresponding to the convex embossment (or, the concave embossment) is formed, the first front end surface corresponding to at least a part of a sectional area of the punch pin; and a punching unit having a second front end surface corresponding to a remained part of the sectional area of the punch pin, the second front end surface having a cutting blade corresponding to the cutting hole and being protruded more than the first front end surface.

Preferably, the cutting hole of the jig is formed to pass through the convex-embossment (or, the concave embossment), and the punching unit is perpendicularly protruded from a center portion of the first front end surface of the embossing unit.

In addition, the jig preferably has upper and lower plates which are faced in parallel with each other so that a gap is interposed therebetween for insertion of the sheet member to be punched, and a length from the first front end surface of the embossing unit to the second front end surface of the punching unit is preferably greater than the gap of the jig.

Also preferably, the cutting hole is formed in the upper and lower plates of the jig, and the convex embossment (or, the concave embossment) is formed on the lower plate of the jig, and a guide hole for guiding movement of the punch pin is formed in the upper plate of the jig.

### BRIEF DESCRIPTION OF THE DRAWINGS

Other objects and aspects of the present invention will become apparent from the following description of embodiments with reference to the accompanying drawing in which:

FIG. 1 is an exploded perspective view showing a punch according to a preferred embodiment of the present invention;

FIG. 2 is a perspective view showing the punch of FIG. 1, which is assembled;

FIG. 3 is a partially sectioned perspective view showing an inner configuration of a jig of FIG. 1 in detail;

FIG. 4 is a side view schematically showing a type of punching member provided to the punch of the present invention;

FIG. 5 is a partially exploded perspective view showing a punching member in correspondence with FIG. 3;

FIG. 6 is a plane view showing an example of a punching and embossing pattern formed in a sheet member according to the present invention;

FIG. 7 is a side view schematically showing another type of punching member provided to the punch of the present invention;

FIG. 8 is a partially exploded perspective view showing a punching member according to the type of FIG. 7;

FIG. 9 is a plane view showing a front end surface of an integrated punch pin of FIG. 8;

FIG. 10 is a partially sectioned perspective view showing an example of the jig in correspondence with FIG. 8;

FIG. 11 is a plane view showing another example of a punching and embossing pattern formed in the sheet member according to the present invention; and

FIG. 12 is a plane view showing that a sheet member is supplied to a punching area for usage of the punch according to the present invention.

### DESCRIPTION OF THE PREFERRED EMBODIMENT

Hereinafter, the present invention will be described in more detail referring to the drawings.

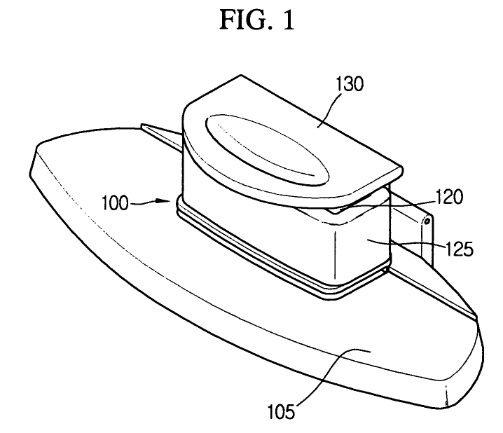

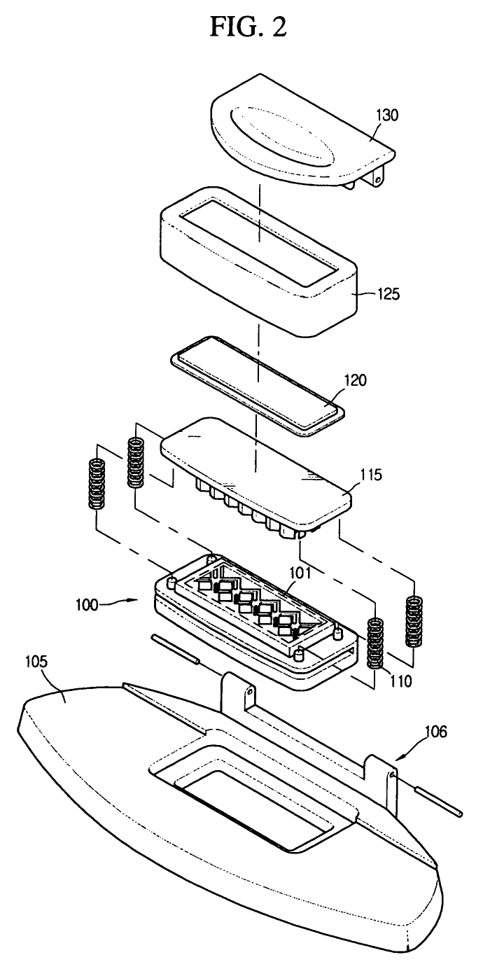

FIG. 1 is an exploded perspective view showing a punch according to a preferred embodiment of the present invention, and FIG. 2 is a perspective view showing the punch of FIG. 1 in an assembled state.

Referring to FIGS. 1 and 2, the punch of the present invention includes a jig 100 having a punching area 101, a base 105 for supporting the jig 100, a punching member 115 for punching and embossing a sheet member supplied to the jig 100 with selectively descending against the jig 100, and a handle 130 used for pressing the punching member 115.

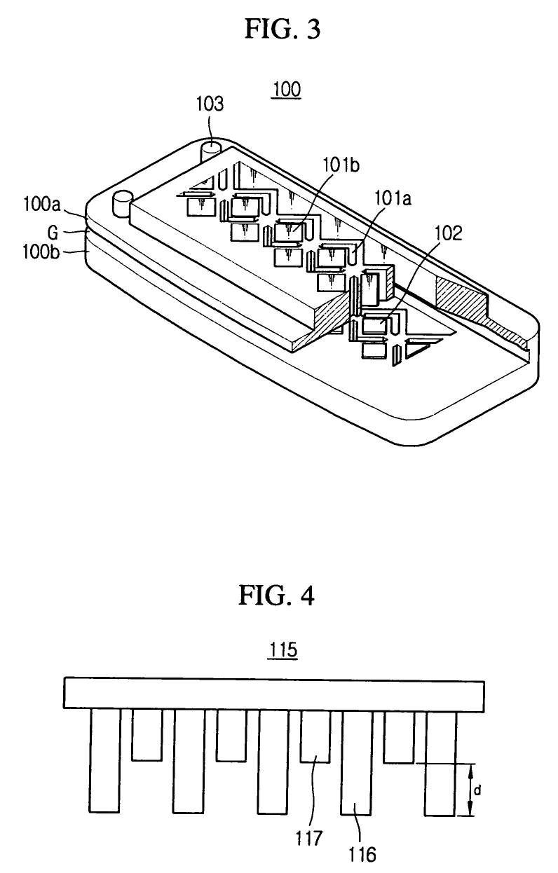

The jig 100 supports the supplied sheet member and gives the punching area 101 for punching and embossing the sheet member in a predetermined pattern. As exemplarily shown in FIG. 3, the punching area 101 of the jig 100 has at least one cutting hole 101a of a predetermined pattern and at least one convex embossment 102 of a predetermined pattern at a position spaced apart from the cutting hole 101a. Here, the punch of the present invention is not limited to the above example, but may be modified so that a concave embossment of a predetermined pattern is formed in the jig 100, of course.

Preferably, the jig 100 may have an upper plate 100a and a lower plate 100b, which are faced in parallel with each other so that a gap G is interposed between them for insertion of a sheet member to be punched. In this case, the cutting hole 101a is formed in the upper plate 100a and the lower plate 100b respectively, and the convex embossment 102 is formed only in the lower plate 100b. Additionally, a guide hole 101b for guiding movement of a corresponding punch pin may be formed in the upper plate 100a in correspondence to the convex embossment 102.

The base 105 supports the jig 100 below it and gives a support surface for supplying a sheet member to the punching area 101.

The punching member 115 is installed to be vertically movable against the jig 100, and acts for punching and embossing a sheet member supplied to the jig 100 when it descends. For convenient handling of the punching member 115, an elastic body 110 for elastically biasing the punching member 115 upward is interposed between the punching member 115 and the jig 100. Preferably, the elastic body 110 is a spring, which is symmetrical to the punching area 101 and biases the punching member 115 upward with being held by a plurality of protrusions 103 formed on the upper plate 100a of the jig 100.

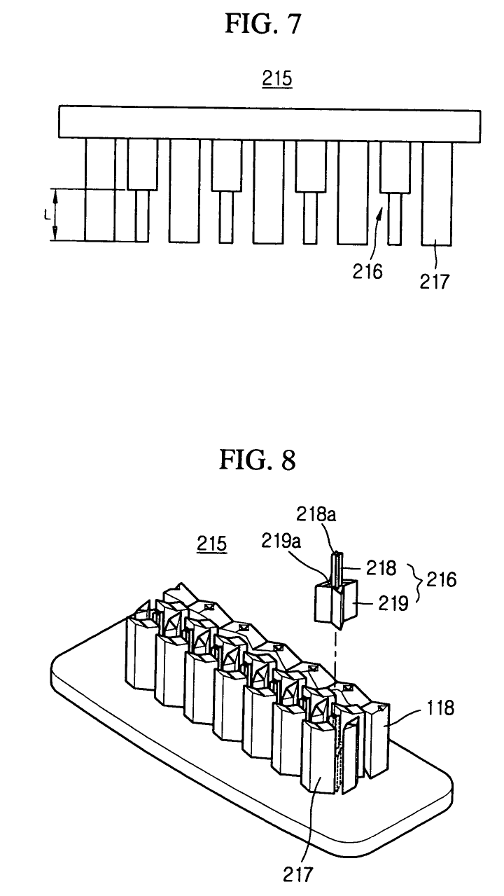

The punching member 115 has an assembly of punch pins, which are respectively corresponding to the cutting hole 101a and the convex embossment 102 of the jig 100 and protruded downward. The punching member 115 may be classified into two types respectively shown in FIGS. 4 and 7 according to the structure of the punch pin assembly.

The punching member 115 schematically shown in FIG. 4 has a punch pin assembly, composed of at least one punch pin 116 having a cutting blade at its front end, and at least one second punch pin 117 having a concave embossment (or, a convex embossment) at its front end and having a body separated from the first punch pin 116. The punching member 115 conducts punching and embossing to a sheet member at the same time when it descends against the jig 100. Here, the first punch pin 116 is preferably longer than the second punch pin 117 for easier punching. More specifically, a length difference d between the first punch pin 116 and the second punch pin 117 is preferably larger than the gap G of the jig 100.

FIG. 5 shows an example of the punching member 115 corresponding to the jig 100 of FIG. 3. The punching member 115 of FIG. 5 is also substantially corresponding to the type of FIG. 4. Referring to FIG. 5, in the punching member 115, a first punch pin 116 corresponding to the cutting hole 101a of the jig 100 and having a cutting blade 116a at its front end and a second punch pin 117 having a concave embossment corresponding to the convex embossment 102 of the jig 100 at its front end 117a are arranged in a predetermined pattern. The first punch pin 116 is longer than the second punch pin 117 as much as at least the gap G of the jig 100. Additionally, the punching member 115 may be further provided with a rim cutting pin 118 for cutting a rim portion of the sheet member in a predetermined pattern.

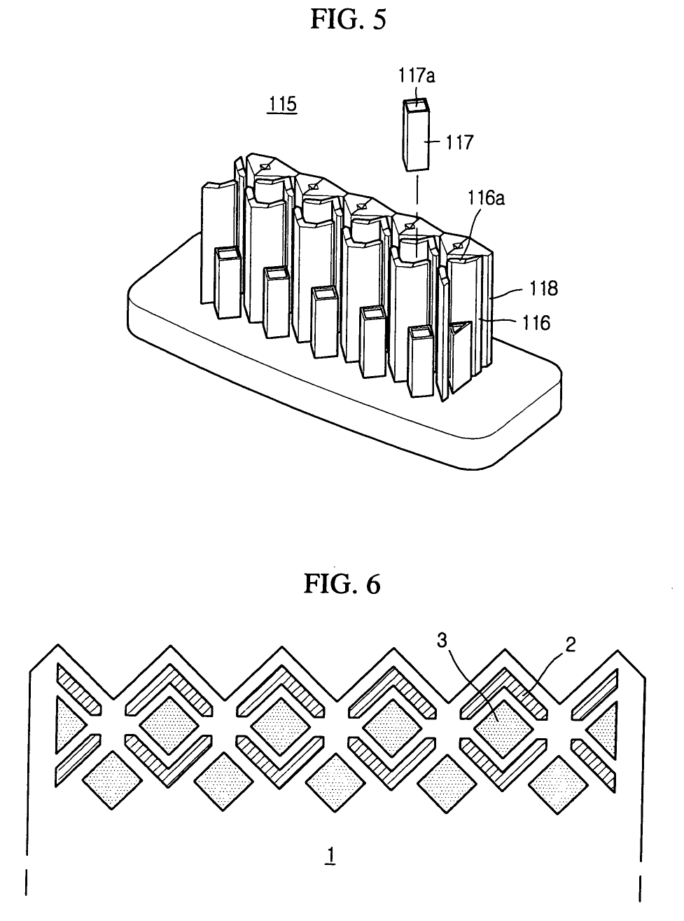

When using the punching member 115 and the jig 100 configured as mentioned above, at a stroke of the punching member 115, the first punch pin 116 passes through the cutting hole 101a of the jig 100 to punch the sheet member, and then the second punch pin 117 is compressed with the convex embossment 102 of the jig 100 with the sheet member positioned between them to emboss the sheet member. Thus, as shown in FIG. 6, a punching pattern 2 and an embossing pattern 3 are formed in the sheet member 1 at the same time. In addition, the rim portion is also cut away in a predetermined pattern.

Meanwhile, FIG. 7 shows a punching member 215 having an integrated punch pin 216, in which an embossing unit and a punching unit are provided integrally. Referring to FIG. 7, at least one integrated punch pin 216 is arranged to the punching member 215 in a predetermined pattern, and other punch pins for either punching or embossing may also be further provided. The integrated punch pin 216 includes an embossing unit of which a diameter is relatively large, and a punching unit protruded from one side of the embossing unit and extended to a front end thereof with a diameter relatively smaller than the embossing unit. In addition, a concave embossment (or, a convex embossment) of a predetermined pattern is formed on the front end surface of the embossing unit of the integrated punch pin 216, and a cutting blade is formed at the front end surface of the punching unit, so the integrated punch pin 216 punches and embosses the sheet member at the same time when it descends against the corresponding jig. In the integrated punch pin 216, the length L from the front end surface of the embossing unit to the front end surface of the punching unit is preferably greater than the gap G of the jig for better punching work.

FIG. 8 shows an example of a punching-member 215 corresponding to the type of FIG. 7 in detail, and FIG. 10 shows a jig 300 corresponding to the punching member 215 as an example.

Referring to FIG. 8 first, the punching member 215 is provided with at least one integrated punch pin 216 of a predetermined pattern, which conducts punching and embossing at the same time. Additionally, the punching member 215 may be further provided with other punch pins 217 for punching only without embossing, and a rim cutting pin 118 for cutting away a rim of the sheet member.

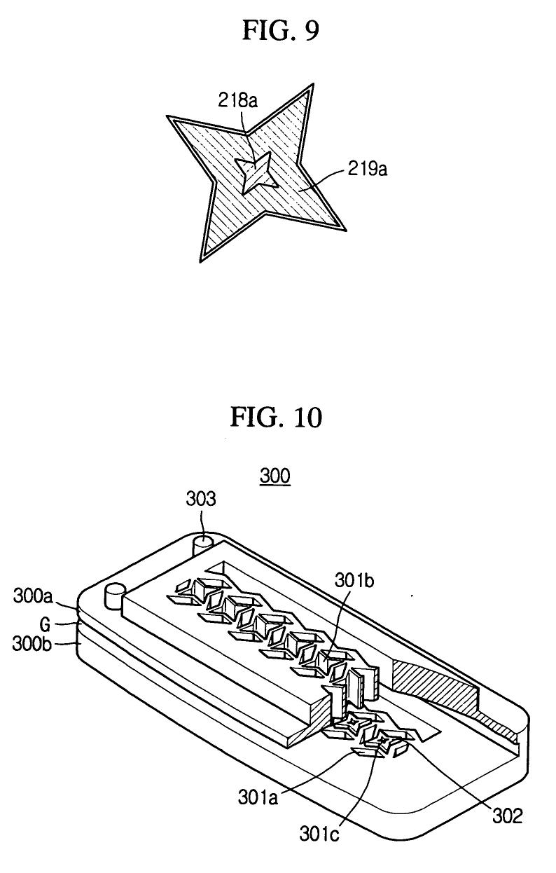

The integrated punch pin 216 includes, as shown in FIG. 9, an embossing unit 219 having a first front end surface 219a on which a concave embossment corresponding to the convex embossment 302 (see FIG. 10) of the jig 300 is formed, and a punching unit 218 having a second front end surface on which a cutting blade corresponding to the cutting hole 301c of the jig 300 is formed.

The first front end surface 219a of the embossing unit 219 is at least corresponding to a partial sectional area of the integrated punch pin 216, and the concave embossment corresponding to the convex embossment 302 of the jig 300 is formed thereon. In addition, the second front end surface 218a of the punching unit 218 is corresponding to a remained sectional area of the integrated punch pin 216, and the cutting blade corresponding to the cutting hole 301c of the jig 300 is formed thereon. The second front end surface 218a is further protruded rather than the first front end 219a. Preferably, the second front end surface 218a of the punching unit 218 may be perpendicularly protruded from the center portion of the first front end surface 219a of the embossing unit 219 so that a punching pattern is formed at the center of an embossing pattern.

The jig 300 of FIG. 10, which corresponds to the punching unit 215, includes a convex embossment 302 of a predetermined pattern formed on the lower plate 300b of the jig 300, and a cutting hole 301c of a predetermined pattern formed in the lower plate 300b at a position adjacent to the convex embossment 302. Preferably, a guide hole 301b for guiding movement of the punch pin corresponding to the convex embossment 302 is formed in the upper plate 300a.

A position of the convex embossment 302 adjacent to the cutting hole 301c may be located out of the convex embossment 302, or at the center of the convex embossment 302. Here, if the cutting hole 301c is formed to pass through the center of the convex embossment 302, it is possible to obtain a design in which a punching pattern is formed at the center of an embossing pattern.

Additionally, it is also possible that cutting holes 301a of a predetermined pattern corresponding to other punch pins 217 of the punching member 215, not adjacent to the convex embossment 302, are formed in the upper and lower plates 300a and 300b.

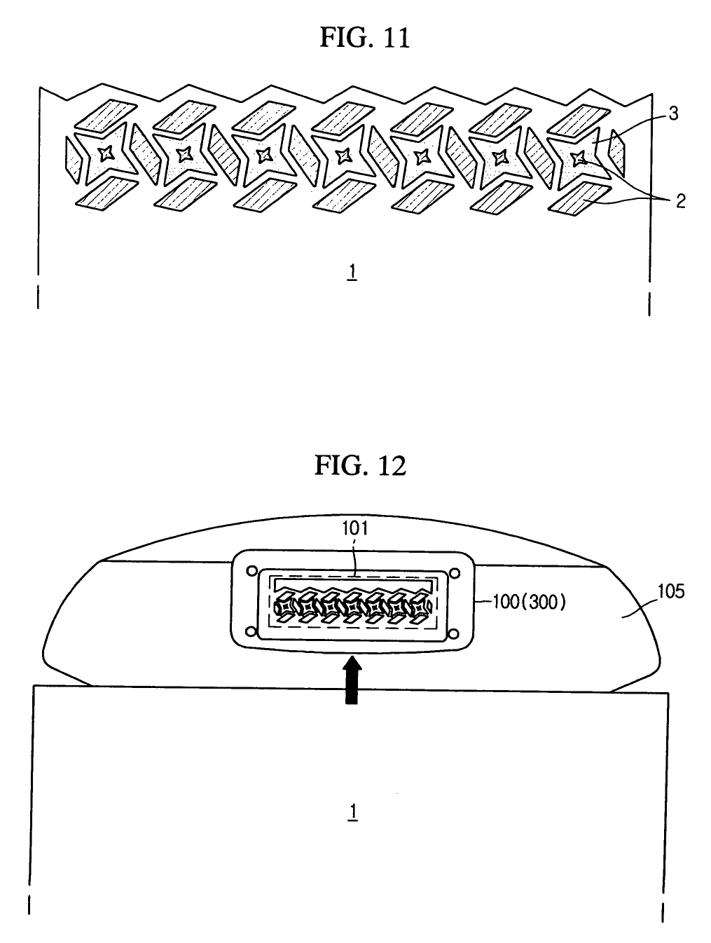

When using the punching member 215 and the jig 300 configured as above, at the stroke of the punching member 215, the punching unit 218 of the integrated punch pin 216 passes through the cutting hole 301c of the jig 300 to punch the sheet member, and then the concave embossment of the embossing unit 219 of the integrated punch pin 216 is compressed with the convex embossment 302 of the jig 300 with the sheet member interposed therebetween to emboss the sheet member. Thus, as shown in FIG. 11, it is possible to obtain a design in which a punching pattern 2 passing through an embossing pattern 3 is formed together with other punching patterns 2, and a rim portion is additionally cut away in a predetermined pattern.

In addition to that, a button member 120 may be combined upon the punching member 115 or 215. The button member 120 is covered by a cap 125, which is combined with the base 105 with an open top, so an upper portion of the button member 120 is partially exposed. A rim portion of the button member 120 around the exposed upper portion is supported by the cap 125 so as to prevent the button member 120 from being deviated out due to an elastic force applied to the punching member 115 or 215. The cap 125 is combined to the lower base 105 with covering not only the button member 120 but also the punching member 115 or 215 and the elastic body 110 in a bundle. According to this configuration, a user may conveniently move the punching member 115 or 215 downward toward the punching area 101 of the jig 100 or 300 by downwardly pressing the button member 120 exposed outward.

Preferably, the button member 120 is pressed by using the handle 130 pivotably connected to one side of the base 105 by means of a hinge 106, which ensures the user to descending the button member 120 more easily.

Now, operation of the punch configured as mentioned above according to a preferred embodiment of the present invention will be described.

First, as shown in FIG. 12, a sheet member is put in the punching area 101 of the jig 100 or 300. Then, a user pushes the handle 130 downward by hand, so the handle 130 is pivoted against the base 105 to press the button member 120 downward. Then, the punching member 115 or 215 also descends toward the punching area 101 of the jig 100 or 300 together with the button member 120, thereby punching and embossing the sheet member in a predetermined pattern.

More specifically, in case the punching member 115 is provided with the first punch pin 116 having the cutting blade 116a and the second punch pin 117 having the concave embossment 117a, and the cutting hole 101a corresponding to the first punch pin 116 and the convex embossment 102 corresponding to the concave embossment 117a are formed in the upper and lower plates 100a and 100b of the jig 100, the first punch pin 116 passes through the cutting hole 101a of the upper plate 100a of the jig 100, the sheet member 1, and the cutting hole 101a of the lower plate 100b subsequently, thereby punching the sheet member, when the punching member 115 descends. After that, the second punch pin 117 descends through the guide hole 101b of the upper plate 100a so as to compress the sheet member 1 between the second punch pin 117 and the convex embossment 102, thereby embossing the sheet member 1.

In addition, in case the punching member 215 is provided with the integrated punch pin 216, which includes the embossing unit 219 having the first front end surface 219a on which the concave embossment is formed and the punching unit 218 having the second front end surface 218a on which the cutting blade is formed, and the convex embossment 302 corresponding to the concave embossment is formed on the jig 300, the second front end surface 218a of the punching unit 218 passes through the guide hole 301b of the upper plate of the jig 300, the sheet member 1 and the cutting hole 301c of the lower plate subsequently, thereby punching the sheet member 1, while the punching member 215 descends. After that, the first front end surface 219a of the embossing unit 219 compresses the sheet member 1 between the first front end surface 219a and the convex embossment 302 of the jig 300, thereby embossing the sheet member 1.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The punch according to the present invention may simultaneously punch and emboss a sheet member by only one stroke, thereby conveniently giving various designs in which a punching pattern and an embossing pattern is mixed.

In addition, since the pins for punching or embossing may be associated in various ways in the punch, it is possible to obtain various punching and embossing designs, which cannot be expected in the prior art.

This punch may be used for punching a sheet member such as a card, a letter paper, a picture, a board, or a paper, which requires decoration, as well as for punching work in offices or industries, thereby improving the beauty thereof.

1. A punch comprising:
a jig having a cutting hole of a predetermined pattern, and a punching area on which a convex embossment (or, a concave embossment) is formed at a position spaced apart from the cutting hole;
a base to which the jig is fixed, the base giving a support surface so that a sheet member to be punched is supplied to the punching area;
a punching member including a first punch pin having a cutting blade corresponding to the cutting hole and a second punch pin having a concave embossment (or, a convex embossment) corresponding to the convex embossment (or, the concave embossment), the punching member punching and embossing the supplied sheet member with moving up and down against the jig; and
an elastic body interposed between the punching member and the jig so as to bias the punching member upward.

2. A punch according to claim 1,
wherein the jig has an upper plate and a lower plate which are faced in parallel with each other so that a gap is interposed therebetween for insertion of the sheet member to be punched,
wherein the first punch pin is longer than the second punch pin as much as at least the gap of the jig.

3. A punch according to claim 2,
wherein the cutting hole is formed in the upper and lower plates of the jig, and the convex embossment (or, the concave embossment) is formed on the lower plate of the jig,
wherein a guide hole for guiding movement of the second punch pin is formed in the upper plate of the jig.

4. A punch comprising:
a jig having a cutting hole of a predetermined pattern, and a punching area on which a convex embossment (or, a concave embossment) of a predetermined pattern is formed at a position adjacent to the cutting hole;
a base to which the jig is fixed, the base giving a support surface so that a sheet member to be punched is supplied to the punching area;
a punching member having punch pins for punching and embossing the supplied sheet member with moving up and down against the jig; and
an elastic body interposed between the punching member and the jig so as to bias the punching member upward,
wherein at least one of the punch pin includes:
an embossing unit having a first front end surface on which a concave embossment (or, a convex embossment) corresponding to the convex embossment (or, the concave embossment) is formed, the first front end surface corresponding to at least a part of a sectional area of the punch pin; and
a punching unit having a second front end surface corresponding to a remained part of the sectional area of the punch pin, the second front end surface having a cutting blade corresponding to the cutting hole and being protruded more than the first front end surface.

5. A punch according to claim 4,
wherein the cutting hole of the jig is formed to pass through the convex embossment (or, the concave embossment),
wherein the punching unit is perpendicularly protruded from a center portion of the first front end surface of the embossing unit.

6. A punch according to claim 4,
wherein the jig has upper and lower plates which are faced in parallel with each other so that a gap is interposed therebetween for insertion of the sheet member to be punched,
wherein a length from the first front end surface of the embossing unit to the second front end surface of the punching unit is greater than the gap of the jig.

7. A punch according to claim 6,
wherein the cutting hole is formed in the upper and lower plates of the jig, and the convex embossment (or, the concave embossment) is formed on the lower plate of the jig,
wherein a guide hole for guiding movement of the punch pin is formed in the upper plate of the jig.
